(19) United States
(12) Patent Application Publication
(10) Pub. No.: US 2018/0008505 A1
(43) Pub. Date: Jan. 11, 2018

(54) "A.J.R. Tool" Massage Therapy Tool

(71) Applicant: Albert Javier Rodriguez, Indio, CA (US)

(72) Inventor: Albert Javier Rodriguez, Indio, CA (US)

(21) Appl. No.: 15/206,120

(22) Filed: Jul. 8, 2016

(51) Int. Cl. A61H 7/00

(52) U.S. Cl. CPC A61H 7/003; A61H 7/007; A61H 2209/00

(57) ABSTRACT

The AJR Tool is used to safely apply pressure to specific areas during massage therapy. The tool's unique shape, combination of rigid and yielding surfaces and lightweight construction distinguish it from any other massage therapy tool.

### RELATED PATENT APPLICATIONS

This invention draws on no other patents and no patents of similar inventions are known.

### Overview

Since the beginning of human history, massage therapy has been used in many ways to relieve human pain and suffering. Massage therapy encompasses many different techniques. Acupressure, for example, is one of many techniques that introduces pressure to very specific areas in the body. Generally speaking, massage therapists manipulate the muscles and other soft tissues of the body. They most often use their hands and fingers, but many use their forearms, elbows, or feet in order to apply additional pressure and reduce fatigue.

### The Problem

To aid in massage therapy, tools have been developed over time with the primary intent of reducing fatigue for the massage therapist as they apply pressure. Without the benefit of directly sensing how much pressure is being applied through the fingers, a massage therapist can unintentionally apply too much pressure which can introduce unintended and possibly harmful results in the patient.

Many patients who rely on massage therapy present problems related to trauma-related injuries. Often, there are circulation problems, inflammation and scar tissue. Current massage tools do not address the treatment of inflammation, blood circulation and scar tissue.

Typically limited to a single material, massage tools have followed traditional designs which are of limited benefit in modem massage therapy and are primarily intended to apply more pressure with less effort.

Massage therapists require a massage therapy tool that can not only safely apply pressure, but relieve inflammation, improve circulation and treat scar tissue.

### The Invention

The invention is a massage therapy tool which has a unique shape that employs multiple surfaces of varying rigidity. By combining rigid surfaces with semi-rigid surfaces in a unique shape, the invention advances modern massage tool technology. The combination of materials and specially designed surfaces make this tool unique.

### SUMMARY OF THE INVENTION

The “AJR Tool” is an invention that is distinguishable from any other invention. It has been designed with a unique shape and special surfaces which employ both rigid and non-rigid materials in unique ways. The shape allows the various surfaces of the invention to be applied with pressure to areas requiring attention. The unique curvature is particularly suitable for compression therapy (compressing the muscle against the bone) and petrissage therapy (kneading of the muscles). Additionally, cross-directional stretching therapy and deep transverse friction therapy are achieved through the semi-rigid material in the tip and ribbed areas. The specially designed ribbed surfaces for scraping and stimulating the skin are unique to this invention. The semi-rigid tip protects the patient from excessive pressure and is perfect and safe for applying percussion therapy techniques.

### Two Iterations

In one iteration (FIGS. 1-6) of this invention, the ribbed portion of the invention is made of rigid material and will not flex.

In a second iteration (FIGS. 7, 8, 9, 14, 15) of this invention, the ribbed portion of the invention is made of semi-rigid material and will flex slightly as pressure is applied.

### LIST OF ILLUSTRATIONS

FIG. 1 Top View of the invention

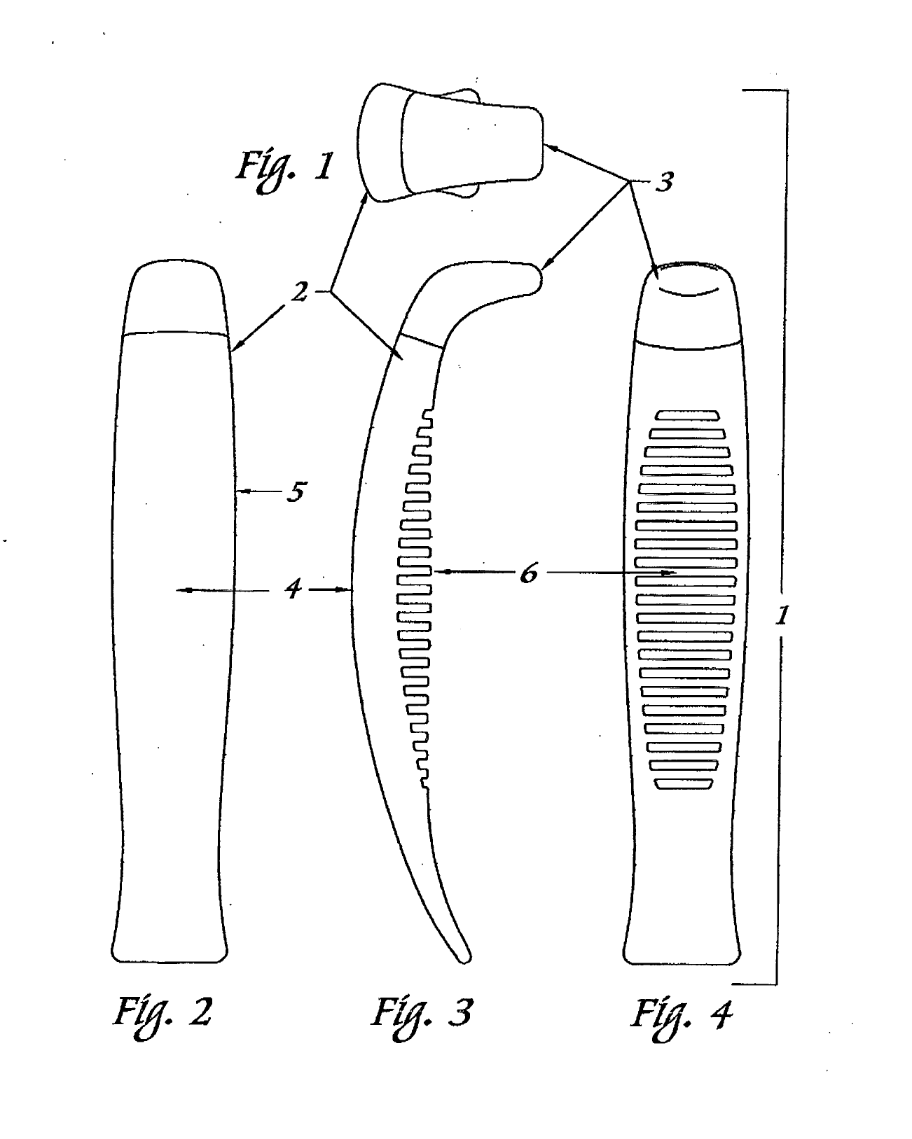

FIG. 2 Back View of the invention

FIG. 3 Side View of the invention (Iteration 1)

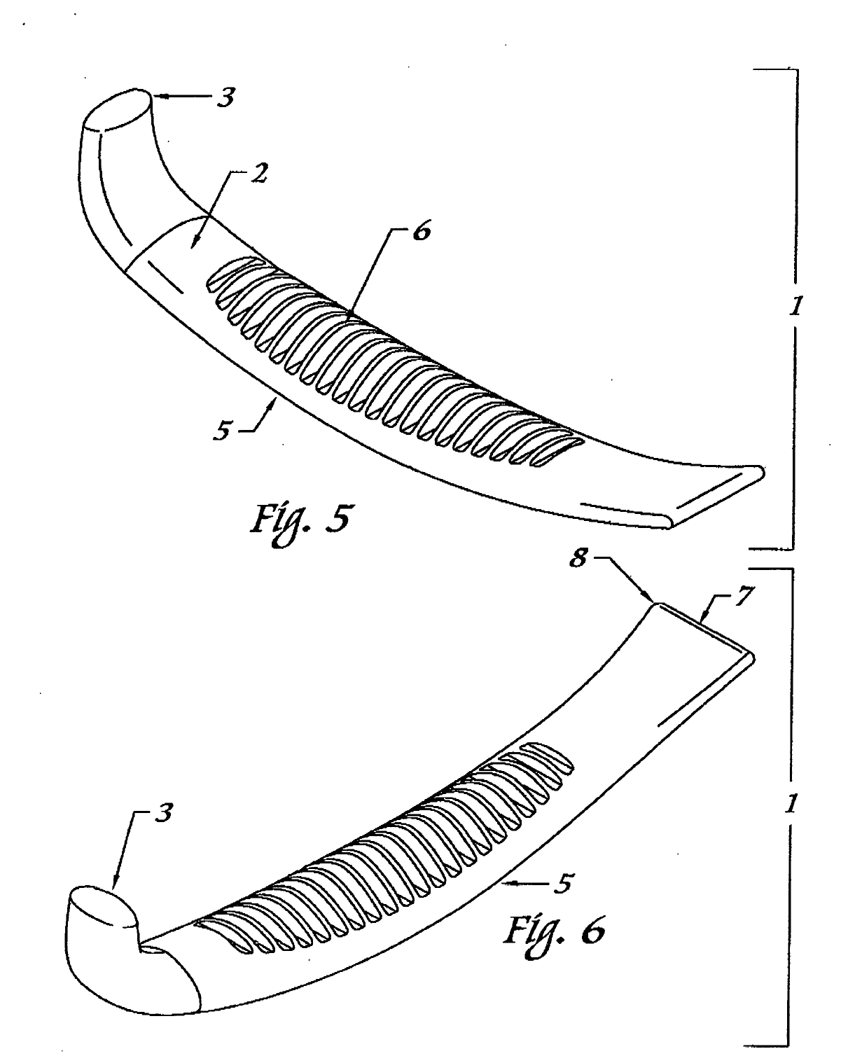

FIG. 4 Front View of the invention (Iteration 1)

FIG. 5 Isometric View of the invention from base end (Iteration 1)

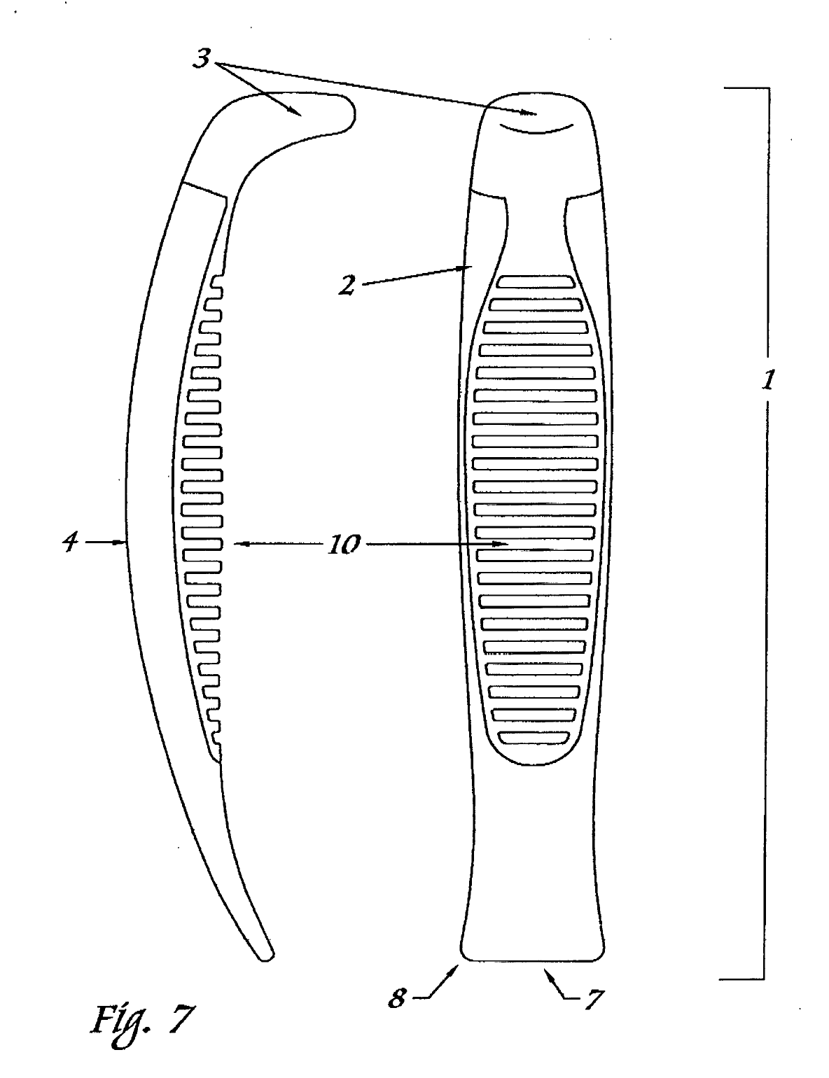

FIG. 6 Isometric View of the invention from tip end (Iteration 1)

FIG. 7 Front and Side View of iteration two of the invention (Iteration 2)

FIG. 8 Isometric View iteration two of the invention from base end (Iteration 2)

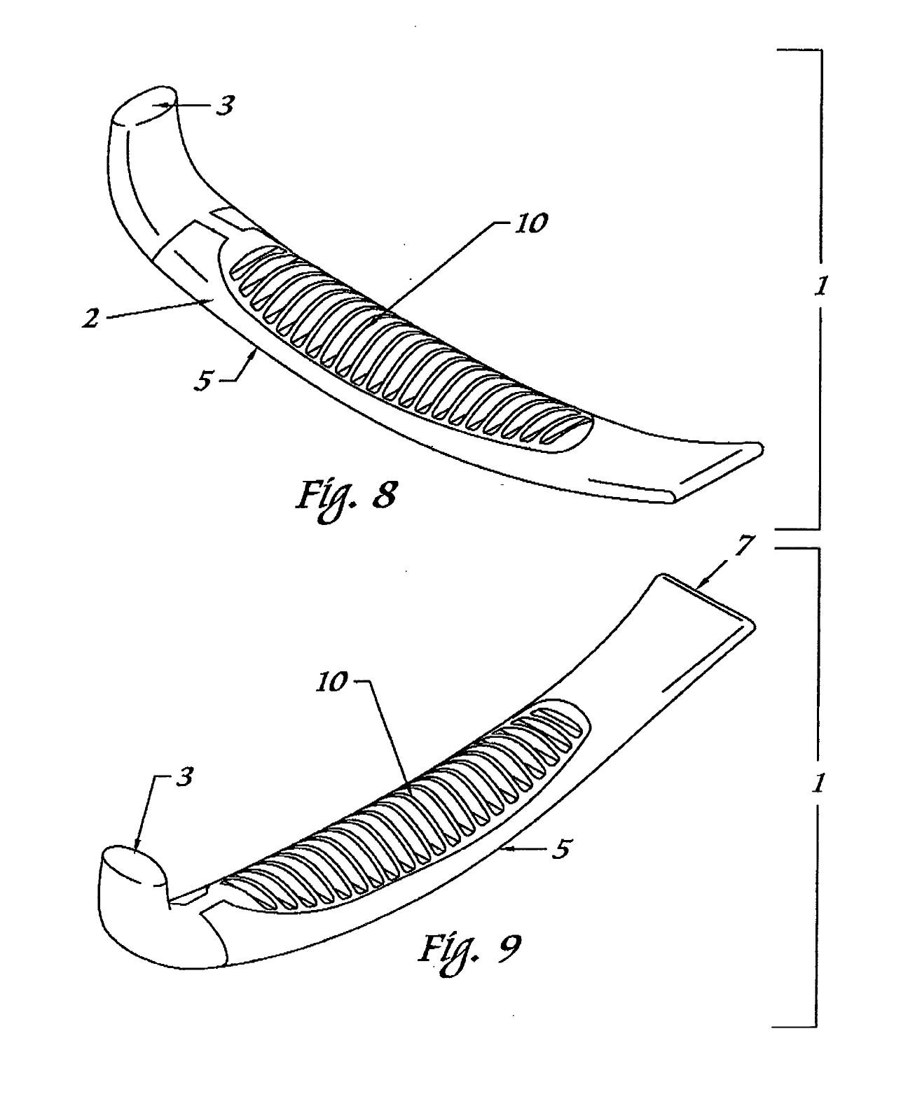

FIG. 9 Isometric View of iteration two of the invention from tip end (Iteration 2)

FIG. 10 Side View of Tip flexing as pressure is applied

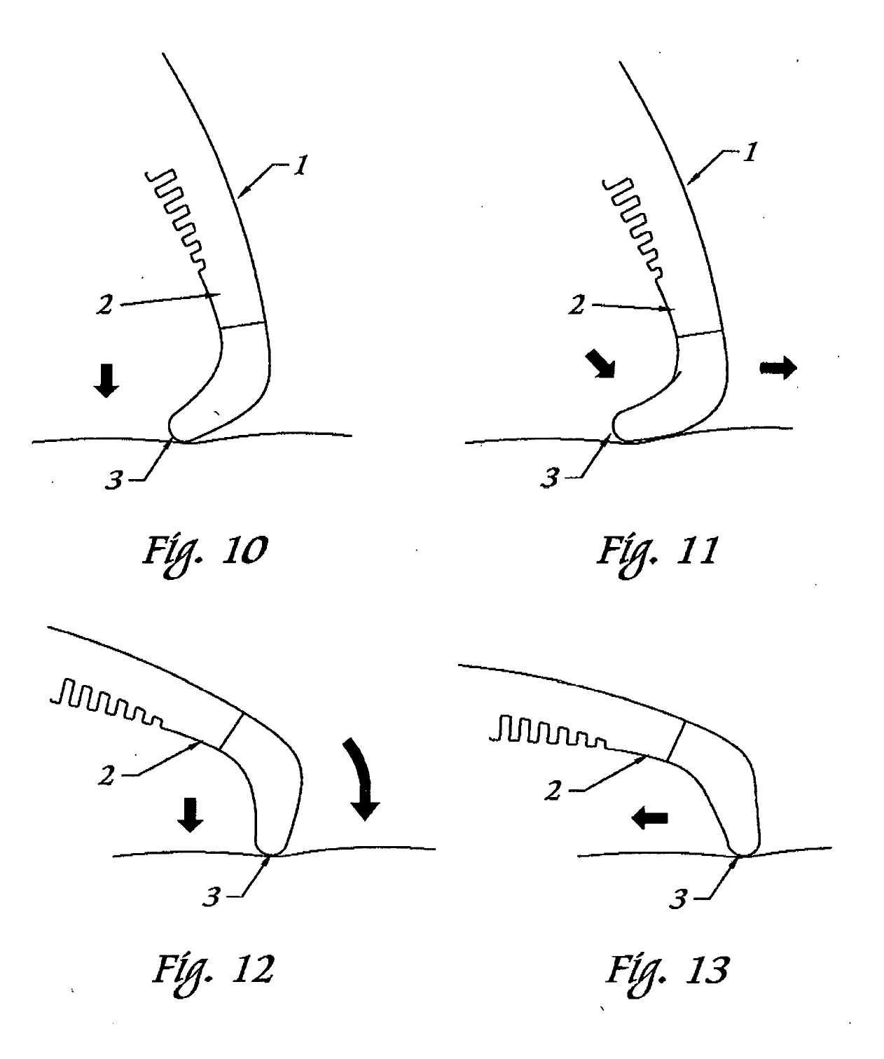

FIG. 11 Side View of Tip flexing while dragging

FIG. 12 Side View of Tip applying direct pressure or during percussion

FIG. 13 Side View of Tip flexing while pulling

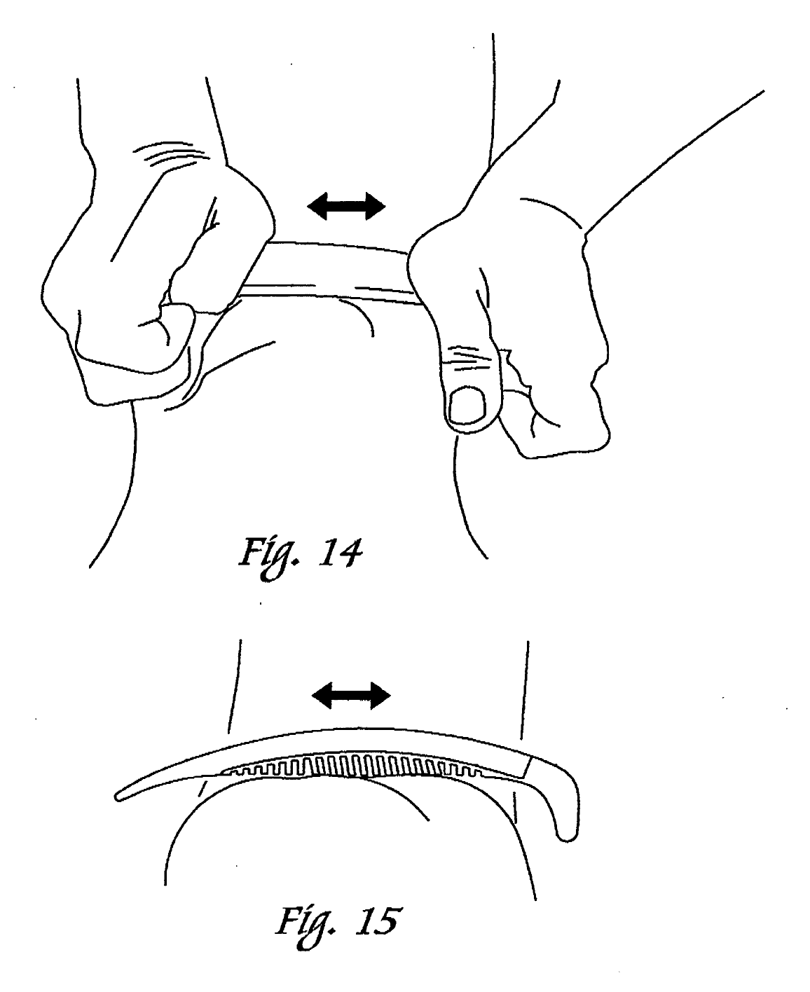

FIG. 14 Treatment using the ribbed area

FIG. 15 Side View of rib deformation (Iteration 2)

### THE INVENTION IS CONFIGURED AS FOLLOWS

The invention [1] consists of the following major parts or elements: (FIGS. 1-16)

A curved stiff body made of rigid material [2].

A curved yielding tip made of semi-rigid (yielding) material [3].

A curved back [4].

Curved sides [5].

A ribbed area which may be made of [6] rigid (Iteration One—FIG. 4) or [10] semi-rigid (Iteration Two—FIG. 7) material.

A flat base [7] with rounded corners [8].

The Invention works as follows:

The invention [1] is applied directly to the patient by the massage therapist. By utilizing the various surfaces of the invention in accordance with various massaging techniques, a favorable outcome may be achieved.

Compression therapy is the compression of tissue or muscle against the bone. The invention is designed so that compression can be assisted by utilizing the back surface [4] of the invention. The curvature of the back surface of the invention is designed to separate the muscle fibers as the compression is applied. The same surface is used for Petrissage therapy which involves the kneading of the muscles. In this therapy, a rocking motion may also be applied. For some areas, facial massage for example, the tip [3] may be used for compression and petrissage. [FIG. 10]

Cross-directional stretching and deep transverse friction therapies can be achieved using the tip surface [3] by dragging it against the direction of the fibers [FIGS. 11, 13]. Additionally, the edge surface [5], the ribs [6], and the base [7] can be used in a scraping manner for tissue stretching.

The semi-rigid tip [3] and the balance of the tool allows percussion therapy to be applied with great precision [FIG. 12] while reducing fatigue for the therapist. Additionally, it permits direct pressure or acupressure to be applied to a specific pressure point [FIG. 10]. The semi-rigid material of the tip helps to minimize the possibility of injury as pressure is applied.

The ribbed area of the invention in both rigid [6] and semi-rigid iterations [10] may be used for skin scraping and for treating scar tissue as well as for stimulating tissues. The flat base [7] may also be used for this. Additionally, these surfaces may be used to help treat problems of circulation and inflammation.

1: A uniquely-shaped multi-functional tool primarily for but not limited to use in the field of massage therapy.

2: A tool with rigid and semi-rigid surfaces capable of applying pressure to specific areas of the human body.

3: A tool for massage therapy utilizing rigid and semi-rigid materials.

4: A tool for massage therapy designed with a curved back, and a flexible tip.

5: A massage therapy tool with a flexible ribbed surface.

6: A massage therapy tool utilizing a ribbed surface of rigid or semi-rigid materials for skin scraping, stimulation and circulation therapy.

7: A tool with a combination of features and surfaces which can be used in a therapeutic way toward the management of swelling and inflammation.

8: A single tool that assists with compression therapy, petrissage therapy, percussion therapy, cross-directional stretching therapy, and deep transverse friction therapy.

9: A tool with a semi-rigid tip that can be used in a therapeutic way to manipulate muscle tissue.
